(19) United States
(12) Patent Application Publication
(10) Pub. No.: US 2014/0061477 A1
(43) Pub. Date: Mar. 6, 2014

(54) ACTIVE DEVICE FOR VIEWING A SCENE THROUGH A DIFFUSING MEDIUM, USE OF SAID DEVICE, AND VIEWING METHOD

(71) Applicants: Gerard Boucourt, Rouffiac Tolosan (FR); Frederic Taillade, Clamart (FR)

(72) Inventors: Gerard Boucourt, Rouffiac Tolosan (FR); Frederic Taillade, Clamart (FR)

(73) Assignees: INSTITUT FRANCAIS DES SCIENCES ET TECHNOLOGIES DES TRANSPORTS DE L'AMENAGEMENT DES RESEAUX, Champs Sur Mame (FR); LATECOERE, Toulouse (FR)

(21) Appl. No.: 13/994,271

(22) PCT Filed: Dec. 14, 2011
(86) PCT No.: PCT/EP2011/072826

§ 371 Date: Nov. 8, 2013

(30) Foreign Application Priority Data
Dec. 15, 2010 (FR) 10/04894

(51) Int. Cl. G01S 17/02

(52) U.S. Cl. CPC G01S 17/02
USPC 250/341.8; 250/338.1

(57) ABSTRACT

An active device (10) for viewing a scene, includes a light source (12) suitable for emitting electromagnetic radiation towards the scene to be viewed. The device (10) also includes a detector (14), and is configured to activate the detector so as to measure at least a portion of the electromagnetic radiation emitted by the light source and returned by the scene viewed. The electromagnetic radiation emitted by the light source (12) is infrared radiation at least partially included within a spectral band, referred to as the “viewing band”, the wavelengths of which are between 8 micrometers and 15 micrometers, and the detector (14) is designed to measure infrared radiation within the viewing band. Such an active viewing device (10) is particularly suited to viewing in foggy or rainy weather. A viewing method is also described.

### TECHNICAL FIELD

The present invention belongs to the field of viewing scenes. More specifically, the present invention relates to a device and method particularly suited to viewing a scene through an atmosphere loaded with aerosols, as is the case, for example, in foggy or rainy weather, in the presence of smoke, etc.

### STATE OF THE ART

Many viewing devices are known, but these are not very suitable for viewing through an atmosphere loaded with aerosol particles. There are two categories of viewing devices: passive devices and active devices.

Passive devices just measure electromagnetic radiation emitted by the scene viewed, whereas active devices emit an electromagnetic radiation towards said scene and measure the echoes of electromagnetic radiation returned by the scene.

Passive devices generally comprise one or several cameras, which measure the electromagnetic radiation in the visible and/or infrared wavelength ranges.

However, a passive device's performance is linked to the luminance levels of any objects to be detected in the scene. Moreover, the contrast between the objects and the background of the scene is very variable, so that it is often very complicated to distinguish the background of the scene from an object to be detected. In addition, viewing at night is difficult for a passive device that is only sensitive in the visible wavelength range.

These limitations of passive devices are also magnified by foggy weather, rain, etc., insofar as the presence of aerosol particles in the atmosphere increases the attenuation to which the electromagnetic radiation emitted by the scene viewed is subjected.

Active viewing devices have the advantage of having ranges that are generally greater than those of passive devices.

It is known, particularly in the field of vehicle driving aids, to utilize active devices of the radar or lidar type.

Radars and lidars are active devices that operate in different wavelength ranges of the electromagnetic spectrum. Radars emit pulses in the radio-frequency range, while lidars emit pulses in the optical range. The optical range comprises in particular the range of infrared wavelengths and the range of visible wavelengths. The radio-frequency range corresponds to electromagnetic waves with wavelengths greater than those of the infrared range.

In practice, radars are not very sensitive to weather conditions, because the wavelengths in question are generally greater than the dimensions of the aerosol particles in the atmospheric medium when it is rainy, foggy, etc.

Nevertheless, radars have several limitations.

Firstly, radars are costly devices. Secondly, radars have difficulty detecting objects with a low RCS (Radar Cross-Section) such as, in the field of vehicle driving aids, pedestrians, two-wheeled vehicles, etc. In addition, in a complex environment such as an urban environment, the presence of multiple echoes makes the analysis of said multiple echoes very complicated.

Lidars are generally not very costly, compared to radars, and are mainly comprised of a light source, emitting a light pulse in the optical range, and a detector.

However, lidars also have limitations.

Firstly, the lidars' performance is very variable according to the LCS (Laser Cross Section) of the scene's objects. In addition, the performance of lidars is very adversely affected by certain weather conditions, in particular foggy weather.

To understand the reasons for this degradation in performance, it is necessary to analyze the propagation of a light pulse through atmosphere charged with aerosol particles.

The aerosol particles mainly have two distinct effects on the light pulse propagation. Firstly, the light pulse is attenuated in transmission. Secondly, a portion of the incident light pulse is returned by the aerosol particles towards the light source: this is the backscattering effect, which gives rise to a dazzling luminous cloud. The combination of these two effects contributes to reducing the contrast of objects in the scene viewed.

Thus, distinguishing between the information (apparent luminance of objects in the scene) and the noise (luminance backscattered by the aerosol particles) becomes very difficult.

In order to reduce the impact of backscattered photons on performance in terms of contrast, “range-gated” active viewing devices are known.

Such devices also comprise a light source and a detector, and are based on a principle of time division multiplexing of the activations of said light source and said detector. When the light source emits a light pulse, the detector is deactivated (turned off or masked by a shutter) so that the detector is not blinded by the photons backscattered by the aerosol particles in the immediate vicinity of the detector.

The detector is subsequently activated during a predefined interval of time, said time interval ending prior to the next emission of a light pulse. During this time interval, the detector measures the echoes of electromagnetic radiation returned by the scene in response to the emission by the light source.

It is understood that the glare effect is reduced, insofar as the aerosol particles in the immediate vicinity of the light source are not measured by the detector.

However, the range-gated active devices only permit the viewing of a portion of the scene located in a limited range of distances relative to the light source. Said range of distances corresponds to the distances for which a light pulse's roundtrip propagation time is within the detector's predefined activation time interval.

In addition, such range-gated active devices must comprise a complex and costly electronic control unit.

### DESCRIPTION OF THE INVENTION

The present invention aims at proposing a solution for the active viewing of a scene, which makes it possible to have good levels of performance in a diffusing atmospheric medium, in particular foggy weather, and which is simple and not very costly to implement.

In addition, the present invention aims at proposing a solution that permits, in certain cases, a scene to be viewed, including in the immediate vicinity of a viewing device according to the invention, unlike range-gated active devices, which are limited to viewing a predefined range of distances away from these devices.

To achieve the objectives mentioned above, the present invention relates, according to a first aspect, to an active viewing device for detecting an object in a scene, comprising a light source suitable for emitting electromagnetic radiation towards the scene to be viewed. The device also comprises a detector and is configured to activate said detector so as to measure at least a portion of the electromagnetic radiation emitted by said light source and returned by the scene viewed. The electromagnetic radiation emitted by the light source is infrared radiation at least partially included within a spectral band, referred to as the “viewing band”, the wavelengths of which are between 8 micrometers and 15 micrometers, and the detector is designed to measure infrared radiation within the viewing band.

Preferably, the viewing band consists of wavelengths between 10 micrometers and 12 micrometers.

One advantage of using this viewing band lies in particular in the fact that backscattering is low for these wavelengths in foggy weather. As a result, the glare effect is significantly reduced by using wavelengths between 8 micrometers and 15 micrometers, such that the viewing device's visibility distance is much greater, in foggy weather, than the meteorological visibility distance.

Alternatively, wavelengths of the viewing band are between 2.7 micrometers and 2.9 micrometers, or between 5.8 micrometers and 6.2 micrometers.

According to particular embodiments, the viewing device comprises one or more of the following characteristics, considered either alone or in any technically possible combination:
the device comprises a means of expanding a beam of the infrared radiation emitted by the light source,
the device is configured to activate the detector simultaneously with the emission of an infrared radiation by the light source,
the device is configured to activate the light source and the detector continuously during active viewing operations,
the light source is a CO₂ laser source or a QCL (“Quantic Cascade Laser”) diode,
the detector is a thermal camera,
the axes of the light source and detector are substantially parallel.

According to a second aspect, the invention relates to using the viewing device according to the invention for viewing a scene through an atmosphere loaded with aerosol particles, more specifically for viewing a scene in foggy or rainy weather.

According to a third aspect, the invention relates to a method for viewing a scene, said method comprising steps of the light source emitting electromagnetic radiation towards the scene to be viewed, and a detector measuring at least a portion of the electromagnetic radiation emitted by said light source and returned by the scene towards said light source. The electromagnetic radiation emitted during the emission step is infrared radiation at least partially included within a spectral band, referred to as the “viewing band”, the wavelengths of which are between 8 micrometers and 15 micrometers, and, during the measurement step, the detector measures infrared radiation within said viewing band.

Preferably, the viewing band consists of wavelengths between 10 micrometers and 12 micrometers.

Alternatively, wavelengths of the viewing band are between 2.7 micrometers and 2.9 micrometers, or between 5.8 micrometers and 6.2 micrometers.

According to particular modes of implementation, the viewing method comprises one or more of the following characteristics, singly or in any technically possible combination:
the step of measurement by the detector is executed simultaneously with the step of emission by the light source,
the emission step and measurement step are executed continuously during active viewing operations.

### PRESENTATION OF THE FIGURES

The invention will be better understood in reading the following description of a non-limiting example, made with reference to the following figures, which are not to scale and which represent:

FIG. 1: a schematic representation of an active viewing device according to the invention,

FIG. 2: a schematic representation of parameters used in an analytical simulation model,

FIG. 3: curves showing the variation by wavelength for extinction μ_{E} and backscattering μ_{B} coefficients, for different types of fog,

FIG. 4: curves showing the different types of fog considered in FIG. 3,

FIG. 5: curves showing the signal-to-noise ratio obtained for two different wavelengths, for different types of fog,

FIG. 6: curves showing the variation by wavelength for a ratio μ_{E}/μ_{B}, for different types of fog,

FIGS. 7a to 7c: images obtained in a fog chamber showing the improvements brought by utilizing a viewing device according to the invention,

FIG. 8: experimental results obtained with a viewing device according to a preferred embodiment,

FIG. 9: a diagram illustrating the main steps of a viewing method according to the invention.

### DETAILED DESCRIPTION OF THE INVENTION

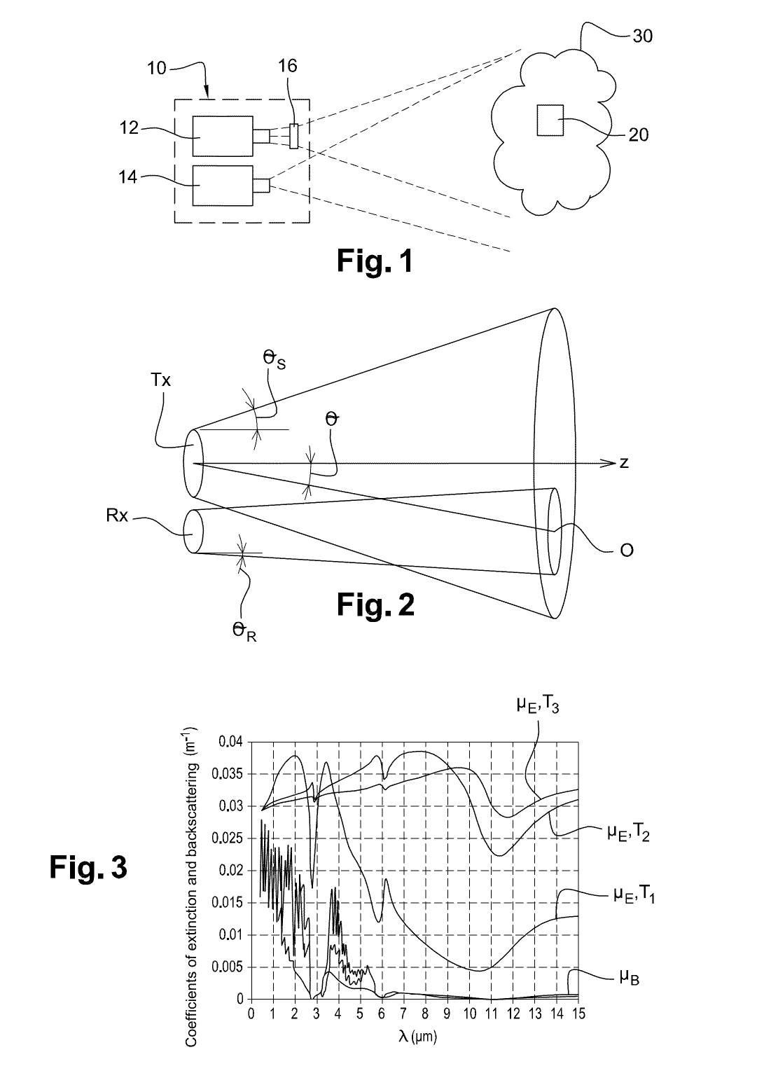

FIG. 1 represents schematically an active viewing device 10 according to the invention, which mainly comprises a light source 12 and a detector 14.

The light source 12 is designed to emit electromagnetic radiation towards a scene. The scene is, for example, comprised of an object 20 to be detected immersed in a diffusing medium 30 of atmospheric type loaded with aerosol particles, more specifically foggy weather. In the rest of the description, the case considered in a non-limiting way, and unless otherwise indicated, is that of viewing a scene in foggy weather.

According to the invention, the electromagnetic radiation emitted by the light source 12 is infrared radiation at least partially included within a spectral band, referred to as the “viewing band”, the wavelengths of which are between 8 micrometers (μm) and 15 μm.

The detector 14 is designed to measure infrared radiation within said viewing band. In addition, the active viewing device 10 is configured to activate the detector 14 so as to measure at least a portion of the electromagnetic radiation emitted by said light source 12 and returned by the scene viewed towards said light source.

In other words, the active viewing device 10 comprises an electronic control unit, of a type known per se and not shown in the figures, which controls the detector 14 so that it measures the infrared radiation returned by the scene in response to the emission of infrared radiation by the light source 12. Indeed, as the device 10 is an active device, the detector 14 must measure the infrared radiation in the viewing band when all or part of the scene viewed is illuminated by the light source 12.

It is therefore understood that the viewing band is within a spectral band corresponding to long wavelength infrared spectrum, known under the acronym LWIR.

It will be seen later that such a choice of wavelengths makes it possible to have good levels of performance in foggy weather. Preferably, the viewing band consists of wavelengths between 10 μm and 12 μm (it will be seen later that such a choice of wavelengths makes possible improvements in the performance of the viewing device 10).

It should be noted that, in the context of the invention, the viewing band is a spectral band common to the light source 12 and the detector 14, i.e. a spectral band in which the light source 12 is designed to emit and in which the detector 14 is designed to measure infrared radiation.

It is understood that, for the light source 12, nothing precludes emitting electromagnetic radiation in a spectral band broader than the viewing band, able to comprise wavelengths not just between 10 μm and 12 μm, or even between 8 μm and 15 μm. Similarly, for the detector 14, nothing precludes measuring electromagnetic radiation in a spectral band broader than the viewing band.

However, it is understood that for reasons of the efficiency of the viewing device 10, the spectral bands of emission (of the light source 12) and measurement (of the detector 14) are preferably substantially the same. Preferably, the emission spectral band is included within the measurement spectral band, so that all the infrared radiation emitted by the light source 12 can be measured by the detector 14. Such provisions make it possible to have a viewing device 10 with improved performance and efficiency.

An analytical model of luminance is now described, and the simulation results obtained with this analytical model are presented, which show the advantages of using the spectral band mentioned above.

The analytical model of luminance described below is based on Mie's theory of light scattering. This theory is assumed to be known to the man skilled in the art and reference may be made in particular to the following reference: Bohren C. F., Huffman D. R., “Absorption and Scattering of Light by Small Particles”, Wiley & Sons (1983).

FIG. 2 represents schematically parameters of the analytical model, in the case of an active device comprising:
an emitter Tx illuminating a band of fog,
a receiver Rx aimed at a portion of said band of fog.

The luminance L_{B} backscattered by the fog and received by the receiver Rx can be approximated by the following expression:

$${L}_{B} = {\int }_{0}^{∞} {μ}_{B} \cdot \frac{{P}_{S}}{TT \cdot ( {R}_{S}^{2} - {z}^{2} \cdot {tan}^{2} ( {θ}_{S} ) )} \cdot \frac{p ( TT - θ ( z ) )}{4 \cdot TT} \cdot cos ( θ ( z ) ) \cdot exp ( - 2 \cdot {μ}_{E} \cdot z ) \cdot ξ ( z ) \cdot d z$$

in which:
P_{S}, R_{S} and θ_{S} are respectively the light power, radius and angular aperture of the emitter Tx,
θ is the angle between the optical center O of the area covered by the receiver Rx at the distance z considered and the optical axis of the emitter Tx,
ξ is a coefficient giving the overlap area between the beam coming from the emitter Tx and the beam of the receiver Rx,
μ_{B}, μ_{E} and p are respectively the backscattering coefficient, the extinction coefficient and the phase function according to the fog, given by Mie's theory.

The validity of the above approximation has been verified in particular in the following scientific publication: Taillade F., Belin E., Dumont E., “An Analytical Model for Backscattered Luminance in Fog: Comparisons with Monte Carlo Simulations and Experimental Results”, Measurement Science and Technology, (2008).

In addition, considering an object in the fog, illuminated by the emitter Tx, its luminance L_{O} seen by the receiver Rx can be approximated by the following expression:

$${L}_{O} = ρ \cdot \frac{{P}_{S}}{TT \cdot {Ω}_{S} \cdot {D}^{2}} \cdot exp ( - 2 \cdot {μ}_{E} \cdot D )$$

in which:
ρ is the albedo of the object at the wavelength considered,
Ω_{S} is the solid angle of the emitter Tx,
D is the distance between the device comprising the emitter Tx and the receiver Rx; exp(−2·μ_{E}·D) thus represents the attenuation of the light over the round trip between said device and the object.

It should be noted that the extinction coefficient μ_{E} is approximately equal to 3/Vₘ, where Vₘ is the meteorological visibility distance. For the man skilled in the art, the meteorological visibility distance Vₘ is defined as the distance for which the luminance transmitted through the atmosphere is attenuated by 95%.

The signal-to-noise ratio SNR, which depends on the ratio of luminance L_{O} of the object to the luminance L_{B} backscattered by the fog, is for example defined according to the following expression:

SNR=10·log (L_{O}/L_{B})

The visibility distance of the active viewing device, comprising the emitter Tx and the receiver Rx, is defined as the distance for which the SNR ratio is zero when expressed in decibels (i.e. when the signal is equal to the noise).

FIG. 3 represents the variation in the extinction μ_{E} and backscattering μ_{B} coefficients for the wavelength considered (designated in the figures by “A”).

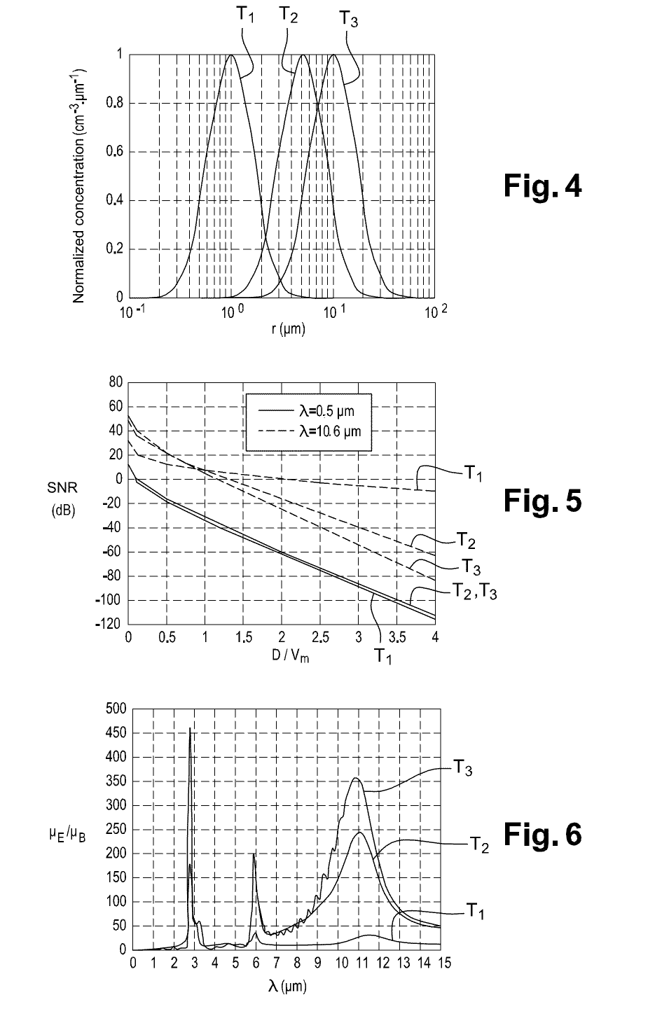

The curves shown in FIG. 3 have been obtained, by simulation with the analytical model of luminance, for three different types of fog, designated respectively by type T1, type T2 and type T3. These types of fog are modeled by lognormal distributions shown in FIG. 4 (such a modeling with a lognormal distribution is known, for example, from: Deirmendjian D., “Scattering and Polarization Properties of Water Clouds and Haze in the Visible and Infrared”, Applied Optics, Vol. 3-1964, page 187).

Type T1 fog corresponds to a particle size distribution centered on 1 μm (i.e. aerosol particles with radius “r” equal to 1 μm are the most numerous). Type T2 fog corresponds to a particle size distribution centered on 5 μm, and type T3 fog corresponds to a particle size distribution centered on 10 μm.

The concentrations of aerosol particles are normalized so that the meteorological visibility distance Vₘ, in the visible spectrum for a wavelength of 0.5 μm (which corresponds approximately to the maximum sensitivity of the human eye), is substantially equal to 100 meters for each type of fog.

FIG. 3 shows that the extinction coefficient μ_{E} varies significantly with the wavelength and the particle size of the fog.

With type T1 fog, it can be seen that the value of the extinction coefficient μ_{E} is lower for wavelengths between 8 μm and 15 μm than for a wavelength of 0.5 μm. The extinction coefficient μ_{E} is substantially equal to 0.005 for a wavelength of 10.5 μm, i.e. a meteorological visibility distance Vₘ of approximately 600 meters at 10.5 μm.

As the particle size of the fog increases, the variations in the extinction coefficient μ_{E} decrease for the wavelengths shown. For example, with type T3 fog the meteorological visibility distance Vₘ varies little with the wavelength.

Surprisingly, the behavior of the backscattering coefficient μ_{B} with the wavelength is very different from that of the extinction coefficient μ_{E}.

Indeed, it can be seen that the values of the backscattering coefficient μ_{B} in a band of wavelengths between 8 μm and 15 μm are much lower than the values of said backscattering coefficient μ_{B} at 0.5 μm, irrespective of the type of fog considered (T1, T2 or T3).

FIG. 5 shows the signal-to-noise ratio SNR obtained by simulation according to the ratio D/Vₘ (Vₘ considered at 0.5 μm), for an active viewing device with wavelength 0.5 μm, and for an active viewing device with wavelength 10.6 μm. It can be seen that the signal-to-noise ratio SNR is noticeably improved in the case of the device 10 with wavelength 10.6 μm.

For example, in the case where the ratio D/Vₘ=1 and irrespective of the type of fog considered, the utilization of an active device with wavelength 10.6 μm theoretically introduces an improvement of 40 decibels (dB) in the signal-to-noise ratio SNR, compared to an active device with wavelength 0.5 μm. In addition it can be seen that, for values of the ratio D/Vₘ less than 1, whereas the lowest extinction coefficient μ_{E} at 10.6 μm was obtained for type T1 fog, the signal-to-noise ratio SNR improvement is smallest with type T1 fog, utilizing the viewing device 10 according to the invention (improvement of 10 dB). In contrast, for values of the ratio D/Vₘ greater than 1 and for type T1 fog, the improvement in the signal-to-noise ratio SNR is greater than for the other types of fog, utilizing the viewing device 10 according to the invention. For type T1 fog, the improvement in the signal-to-noise ratio SNR at 10.6 μm is partly due to the increase in the luminance L_{O} because the extinction coefficient μ_{E} is lower at 10.6 μm than at 0.5 μm.

FIG. 6 shows the variations in ratio μ_{E}/μ_{B} according to the wavelength considered.

It can be seen that the ratio μ_{E}/μ_{B} tends towards zero for a wavelength of 0.5 μm. The ratio μ_{E}/μ_{B} is higher in the viewing band mentioned above. It can be seen, for example, that for type T2 and T3 fogs the ratio μ_{E}/μ_{B} is greater than 50 for wavelengths between 8 μm and 15 μm, and greater than 150 for wavelengths between 10 μm and 12 μm.

The spectral band of wavelengths between 10 μm and 12 μm is also interesting in the case of type T1 fog, insofar as the ratio μ_{E}/μ_{B} shows a local maximum in this spectral band (around 11.5 μm).

The advantages of using the viewing band with wavelengths between 8 μm and 15 μm, or between 10 μm and 12 μm, can therefore be understood. Indeed, a significantly improved visibility distance in foggy weather is expected, mainly because of the very low level of backscattering at these wavelengths.

In a particular embodiment of the viewing device 10 according to the invention, the light source 12 is a CO₂ laser. This example is not limiting, and it is understood that other types of light sources can be utilized to emit infrared radiation in the LWIR spectral band, such as QCL diodes.

Preferably, the viewing device 10 comprises a means of expanding a beam of the infrared radiation emitted by the light source 12, such as a diverging infrared lens 16. Such a lens 16 is shown schematically in FIG. 1.

It is understood that utilizing such an expansion means makes it possible to increase the solid angle illuminated by the light source 12, and thus to increase the field of vision in foggy weather, provided that the detector 14 is designed to measure the infrared radiation returned by all the illuminated portion of the scene.

Preferably, the detector 14 is a matrix detector adapted to form a two-dimensional image of the scene viewed with a single measurement, such as an LWIR thermal camera. According to other examples, the detector 14 is a microbolometer, an infrared camera based on Mercury-Cadmium-Tellurium (MCT), etc.

In a particular embodiment, compatible with any one of the preceding embodiments, the viewing device 10 is configured to activate the detector 14 simultaneously with the emission of an infrared radiation by the light source 12.

In other words, the electronic control unit of the viewing device 10 controls the detector 14 so that it measures the infrared radiation of the scene, including during the emission of infrared radiation by the light source 12.

It is understood that activating the detector 14 at the same time as the light source 12 emits infrared radiation is made possible by using wavelengths within the viewing band mentioned above (between 8 μm and 15 μm, or even between 10 μm and 12 μm), since backscattering and the glare effect are very low in that range.

Such provisions make it possible to have a simple electronic control unit, insofar as the detector 14 can be activated in a continuous way during active viewing operations. In particular, the electronic control unit is simpler than in the case of range-gated active devices. In addition, activating the detector 14 continuously means that viewing the scene does not have to be restricted to a limited range of distances, as is the case for range-gated active devices.

An example of a detector operating in a continuous way is a CCD thermal camera, which produces successive images of the scene at a predefined frequency.

The light source 12 can be activated so as to illuminate the scene viewed continuously or discontinuously. Preferably, the light source 12 is activated continuously, so as to reduce the complexity of the electronic control unit.

“Illuminate discontinuously” means that the light source 12 emits pulses of light.

“Illuminate continuously” means that the light source 12 is activated permanently during active viewing operations. Nothing precludes acquiring a first image with the viewing device 10 in a passive way, i.e. with the light source 12 switched off, and then acquiring a second image in an active way with the light source 12 activated permanently during the entire acquisition of said second image.

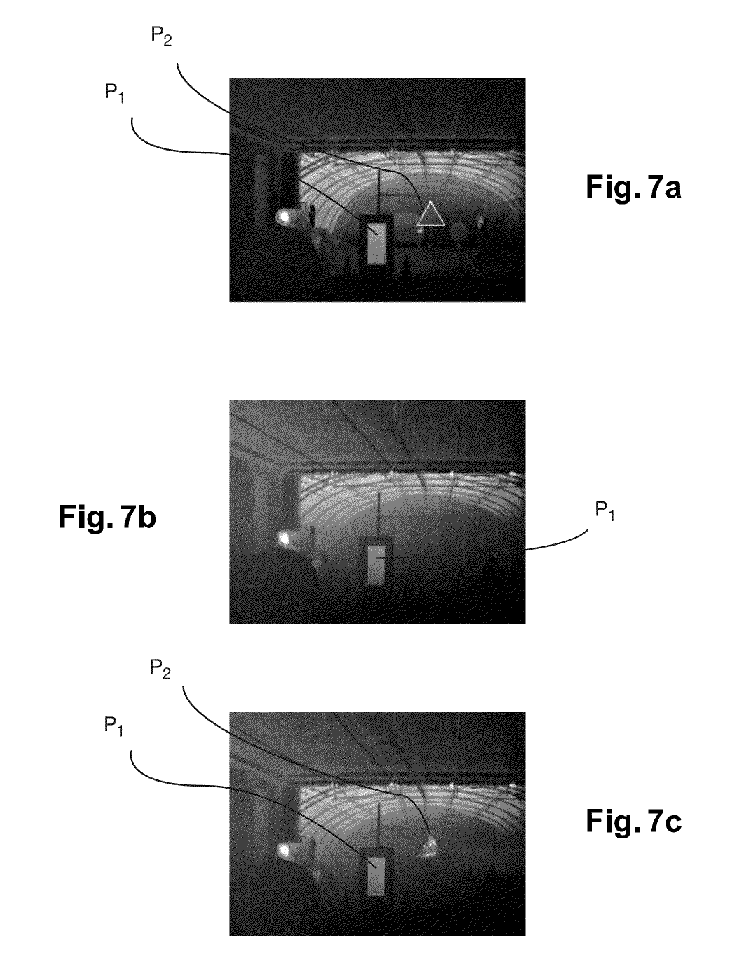

FIGS. 7a to 7d show images of a scene obtained experimentally in a fog chamber. Said images have been obtained under real conditions with a viewing device 10 according to a preferred embodiment, wherein said device comprises:
a CO₂ Laser (COHERENT-Diamond C-30A) type of light source 12 emitting radiation at 10.6 μm,
a lens with a focal length of 25 millimeters to expand the infrared beam emitted by the light source 12 (approximately 1 meter in diameter at 25 meters),
a thermographic camera (FLIR A320) type of detector 14 with 320×240 pixels of uncooled microbolometers, temperature resolution of 50 mK at 30° C., designed to measure infrared radiation between 7.5 μm and 13 μm.

To obtain these results, the CO₂ laser and the thermographic camera have been arranged close to each other, in this example approximately 0.5 meters apart, and such that their axes are substantially parallel (i.e. they are directed substantially towards the same area of the scene viewed). In this way, the thermographic camera is arranged so as to be able to measure at least one portion of the infrared radiation returned by the scene towards the CO₂ laser.

FIGS. 7a and 7b show images obtained with the light source 12 switched off, and FIG. 7c shows an image obtained by the detector 14 with the light source 12 activated, in accordance with the invention.

FIG. 7a shows an image obtained in the absence of fog. Various elements were positioned in the scene viewed, visible in FIG. 7a:
a rectangular plate P₁, brought to a temperature of 30° C., located 10 meters from the viewing device 10,
a triangular panel P₂, brought to a temperature of 27° C., located 25 meters from the viewing device 10.

The background of the scene is at a temperature of 27° C., such that plate P₁ and panel P₂ have different thermal contrasts C_{T}, respectively C_{T}≈0.11 and C_{T}=0 (it should be noted that the outline of panel P₂ has been added so as to locate the panel in the image, said panel not being visible because its thermal contrast C_{T} is zero).

FIG. 7b shows an image obtained, the light source 12 being switched off, in the presence of fog (particle size distribution centered between an aerosol particle radius of approximately 0.5 μm and 1 μm) with a meteorological visibility distance Vₘ of 8 meters. It can be seen that plate P₁ is visible. The panel P₂ is not visible.

FIG. 7c shows an image obtained by the detector 14 under the same conditions as FIG. 7b, but with the light source 12 activated continuously, the scene consequently being illuminated by the light source 12 during measurements by the detector 14.

First of all, the expected absence of the glare effect can be observed. Secondly, it can be seen that the panel P₂ (with thermal contrast C_{T} zero) is visible in FIG. 7c but not in FIG. 7b, the luminance measured for said panel ranging up to saturation of the detector 14.

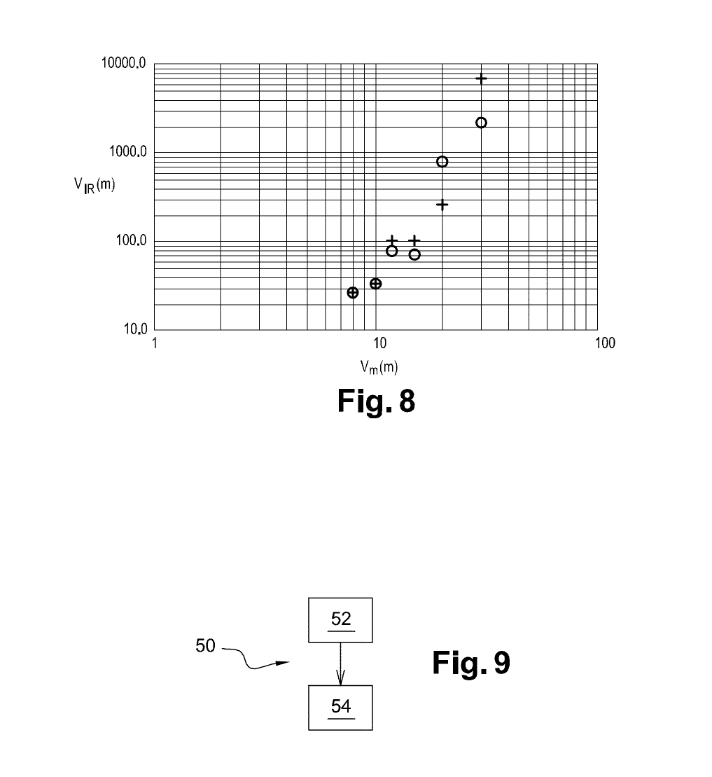

FIG. 8 shows the changes in the visibility distance V_{IR}, obtained with the viewing device 10, as a function of the meteorological visibility distance Vₘ.

The visibility distance V_{IR} is estimated as described below.

In the total absence of fog, the light source 12 being activated, the maximum contrast C₀ of the panel P₂ is measured taking the temperature of the background of the scene as the reference temperature. Then, in the presence of fog and for different values of the meteorological visibility distance Vₘ, the apparent contrast C_{A} of the panel P₂ is measured as previously, with the light source 12 activated. The visibility distance V_{IR} is determined according to the following expression:

$${V}_{IR} = - \frac{D}{3 \cdot ln ( {C}_{A} / {C}_{0} )}$$

in which D is the distance between the panel P₂ and the viewing device 10, i.e. 25 meters. In this FIG. 8, two values of the visibility distance V_{IR} are shown for each meteorological distance Vₘ considered, (represented respectively by a circle and a cross). These two values of the visibility distance V_{IR} are obtained by considering two different reference areas of the background of the scene, in order to determine the apparent contrast C_{A} of the panel P₂.

From reading FIG. 8, it can be seen that, for a meteorological visibility distance Vₘ of 20 meters, in the spectral range chosen (around 10.6 μm) the contrast of objects is that which would have been obtained for objects located between 300 and 800 meters (provided that the objects are large enough for resolution by the detector 14).

In conclusion, the viewing device 10 according to the invention makes it possible to achieve a 15 to 40 fold improvement between the visibility distance V_{IR} (obtained with said device) and the meteorological visibility distance Vₘ.

In addition, the viewing device 10 allows objects with a thermal contrast C_{T} of zero to be detected, provided these objects to be detected have a non-zero albedo in the spectral band considered (between 8 μm and 15 μm).

The experimental results corroborate the results obtained by simulation, so that the approximations or any imperfections of the analytical model of luminance, used for the simulations, cannot call the invention into question, insofar as it has been verified that it actually provides the advantages identified by simulation with said analytical model of luminance.

FIG. 9 represents schematically the main steps of a viewing method 50 according to the invention, which are:
52 the emission of electromagnetic radiation by the light source 12 towards the scene to be viewed,
54 the measurement by a detector 14 of at least a portion of the electromagnetic radiation emitted by the light source 12 and returned by the scene towards said light source.

As indicated previously, the electromagnetic radiation emitted during the emission step 52 is infrared radiation at least partially included within the viewing band (between 8 μm and 15 μm, or even between 10 μm and 12 μm) and the detector 14 measures infrared radiation in said viewing band during the measurement step 54.

Preferably, the measurement step 54 is executed simultaneously with the emission step 52. The measurement step 54 is advantageously executed continuously during active viewing operations. Preferably, the emission step 52 is also executed continuously, i.e. the light source 12 illuminates the scene viewed continuously (in contrast to illumination by pulses of light).

The present invention proposes a viewing device 10 particularly suited to viewing in foggy weather, in particular a fog with a particle size greater than 5 μm. In addition, it has also been verified that the viewing device 10 presents good levels of performance in rainy weather, in particular by simulation with the analytical model mentioned above, considering aerosol particles with a particle size distribution centered approximately on 200 μm.

It is understood, however, that the viewing device 10 can also be used in other contexts, including clear weather, in the presence of smoke, etc.

The viewing device 10 according to the invention can be used in many fields. For example, the viewing device 10 is installed in a vehicle (automobile, aircraft, boat, etc.) as a driving aid in foggy weather. According to another non-limiting example, the viewing device 10 is carried by a user to help him move around or get his bearings with respect to his surroundings in foggy weather.

More generally, from reading FIG. 6, it can be seen that the ratio μ_{E}/μ_{B} shows a local maximum between 2.7 μm and 2.9 μm, and between 5.8 μm and 6.2 μm. In addition, from reading FIG. 6, it can be seen that the extinction coefficient μ_{E} is lower around 2.8 μm or 6 μm than around 0.5 μm.

It can therefore be understood that, according to the simulation results, a significantly improved visibility distance in foggy weather is also expected with an active device with a wavelength substantially equal to 2.8 μm or 6 μm. Thus, the present invention also, according to other embodiments, relates to active devices operating between 2.7 μm and 2.9 μm or between 5.8 μm and 6.2 μm. However, the viewing band with wavelengths between 8 μm and 15 μm corresponds to a preferred embodiment and mode of implementation of the invention.

1-10. (canceled)

11. Active device for viewing a scene, comprising a light source designed to emit electromagnetic radiation, towards the scene to be viewed, at least partially included within a spectral band, referred to as the “viewing band”, the device being configured to activate a detector so as to measure, within the viewing band, at least a portion of the electromagnetic radiation emitted by the light source and returned by the scene, wherein the wavelengths of the viewing band are between 8 micrometers and 15 micrometers, or between 2.7 micrometers and 2.9 micrometers, or between 5.8 micrometers and 6.2 micrometers.

12. Device according to claim 11, wherein it comprises a means of expanding a beam of the electromagnetic radiation emitted by the light source.

13. Device according to claim 11, wherein it is configured to activate the detector simultaneously with the emission of an electromagnetic radiation by the light source emits.

14. Device according to claim 13, wherein it is configured to activate the light source and the detector continuously during active viewing operations.

15. Method for viewing a scene which comprises:
providing the viewing device a claim 11; and
using the viewing device for actively viewing a scene in foggy or rainy weather.

16. Method for viewing a scene, wherein it comprises the following steps:
a. the emission of electromagnetic radiation by a light source towards the scene to be viewed, said electromagnetic radiation emitted by the light source being at least partially included within a spectral band, referred to as the “viewing band”, the wavelengths of which are between 8 micrometers and 15 micrometers, or between 2.7 micrometers and 2.9 micrometers, or between 5.8 micrometers and 6.2 micrometers,
b. the measurement, within the viewing band, by a detector of at least a portion of the electromagnetic radiation emitted by said light source and returned by the scene towards said light source.

17. Method according to claim 16, wherein the step of measurement by the detector is executed simultaneously with the step of emission by the light source.

18. Method according to claim 17, wherein the emission step and measurement step are executed continuously during active viewing operations.
